(19) United States
(12) Patent Application Publication
(10) Pub. No.: US 2013/0168603 A1
(43) Pub. Date: Jul. 4, 2013

(54) MOLDABLE DESICCANT AND HYDROGEN GETTERING SYSTEM

(71) Applicant: Honeywell Federal Manufacturing & Technologies LLC, Kansas City, MO (US)

(72) Inventors: James Ralph Schicker, Lee's Summit, MO (US); Jason Allen Knight, Lawrence, KS (US)

(73) Assignee: Honeywell Federal Manufacturing & Technologies, LLC, Kansas City, MO (US)

(21) Appl. No.: 13/720,440

(22) Filed: Dec. 19, 2012

Related U.S. Application Data
(60) Provisional application No. 61/580,954, filed on Dec. 28, 2011.

(51) Int. Cl. B01J 20/18; C09K 3/00

(52) U.S. Cl. CPC B01J 20/18; C09K 3/00
USPC 252/194; 264/523; 427/372.2; 264/524

(57) ABSTRACT

A composite useful for both gas gettering and moisture adsorption comprising an organic getter component and a desiccant component homogeneously dispersed in an elastomeric matrix. The getter component comprises an organic material capable of reacting with hydrogen and a hydrogenation catalyst. The desiccant component is a molecular sieve. The composite is a resilient, self-sustaining body that can also function as a shock absorber. A method of forming composites useful for both gas gettering and moisture adsorption is also disclosed, along with a kit to facilitate the same.

### CROSS-REFERENCE TO RELATED APPLICATIONS

The present application claims the priority benefit of U.S. Provisional Patent Application Ser. No. 61/580,954, filed Dec. 28, 2011, entitled RTV SILICONE MOLDABLE MATRIX INCORPORATING 3 ANGSTROM MOLECULAR SIEVE DESICCANT AND DEB ORGANIC HYDROGEN GETTER, incorporated by reference in its entirety herein.

### FEDERALLY SPONSORED RESEARCH OR DEVELOPMENT

This invention was made with government support under #DE-NA0000622 awarded by the United States Department of Energy. The United States government has certain rights in the invention.

### BACKGROUND OF THE INVENTION

1. Field of the Invention

The present invention relates to a composite that combines both desiccation and gas gettering into a single article.

2. Description of Related Art

Various devices, including electronics, have requirements for desiccation of moisture and scavenging of undesirable gases, such as hydrogen, oxygen, and/or carbon dioxide, which can interfere with proper functioning of the device components or decrease their working life. Getters are particularly important in sealed systems, where other components such as the plastics, foams, or other materials can off-gas or release undesirable moisture into the closed system. Desiccants and gas getters are typically provided as separate products that are placed in the device compartment. Desiccants are typically provided as bagged granules or in pelletized form. Getters are often provided in tubes or as a molded component.

The use of two separate products poses issues for device design. An area within the device compartment must accommodate two separate items, neither of which provides any structural support, or other mechanical functionality. In addition, their incorporation into the design can also reduce structural integrity. Therefore, improved systems for desiccation and gas gettering are needed.

### SUMMARY OF THE INVENTION

The present invention is broadly concerned with a composite useful for both gas gettering and moisture adsorption comprising an organic getter component and a desiccant component homogeneously dispersed in an elastomeric matrix.

A method of forming a composite useful for both gas gettering and moisture adsorption is also disclosed. The method uses an organic getter component comprising an organic material capable of reacting with hydrogen, a hydrogenation catalyst, and a desiccant component. The getter component is mixed with desiccant component in an elastomeric matrix to form a composite mixture, and the composite mixture is cured to form the cured composite.

Also described herein is a kit for forming a composite useful for both gas gettering and moisture adsorption. The kit comprises an organic getter component comprising an organic material capable of reacting with hydrogen and a hydrogenation catalyst; a desiccant component; an elastomeric matrix component comprising separate parts A and B; and instructions for making the composite. Such instructions include combining part A and part B for forming the elastomeric matrix, mixing the organic getter component and the desiccant component in the elastomeric matrix to form a composite mixture, and curing the composite mixture to form the composite.

### BRIEF DESCRIPTION OF THE DRAWINGS

FIG. 1 is a flow diagram of a process for preparing the moldable desiccant and gas gettering composite formed in Example 1;

FIG. 2 is a graph showing the moisture uptake of composite samples with varying surface area to volume ratios from Example 2;

FIG. 3 is a graph of the total amount of weight change (gain) for each of the composite samples in Example 2;

FIG. 4 is a graph comparing the rate at which the weight of each sample changed for each of the composite samples in Example 2; and

FIG. 5 is a graph illustrating the gettering of hydrogen gas by the composites from Example 2.

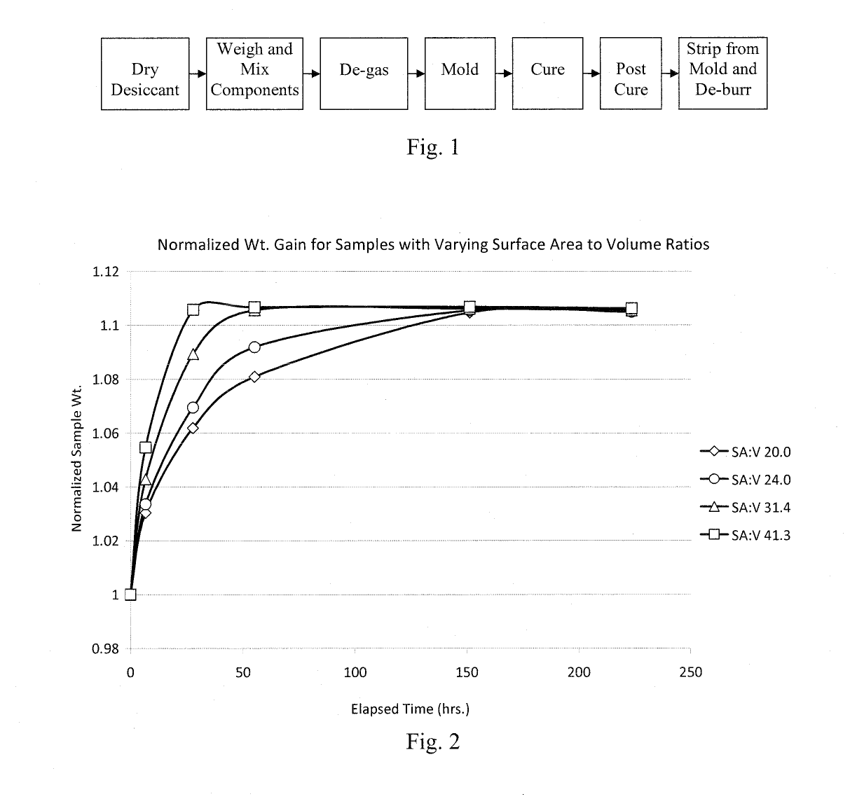

### DETAILED DESCRIPTION

The present invention is concerned with improved gas gettering and moisture desiccation using composite materials capable of both gas gettering and moisture adsorption in a single article. In other words, the invention provides a single article capable of simultaneous gas gettering and moisture adsorption. The composite comprises (consists essentially, or even consists of) a getter component and a desiccant component homogeneously dispersed (i.e., evenly or uniformly distributed) throughout an elastomeric matrix. In one or more embodiments, the composite will comprise at least about 50% by weight of the elastomeric matrix, based upon the total weight of the composite taken as 100% by weight. Those skilled in the art will appreciate that the relative amounts of the getter component and desiccant component in the composite will depend upon the moisture or gas removal needs. Thus, the weight ratio of desiccant to getter can range from about 1:100 to about 100:1, although ratios of at least about 2:1 desiccant to getter may be preferred in some embodiments, In one or more embodiments, the composite comprises from about 3 to about 20% by weight of the getter component, preferably from about 5 to about 15% by weight, and more preferably from about 5 to about 10% by weight of the getter component, based upon the total weight of the composite material taken as 100% by weight. In one or more embodiments, the desiccant component is present in the composite at a level of from about 5 to about 47% by weight, preferably from about 30 to about 45% by weight, and more preferably from about 35 to about 45% by weight, based upon the total weight of the composite taken as 100% by weight. In one or more embodiments, the elastomeric matrix is preferably present in the composite at a level of from about 50 to about 75% by weight, more preferably from about 50 to about 70% by weight, and even more preferably from about 50 to about 60% by weight, based upon the total weight of the composite taken as 100% by weight.

The getter component comprises (consists essentially, or even consists of) an organic material capable of reacting with hydrogen and a hydrogenation catalyst. Suitable organic materials scavenge hydrogen from the gas phase through a chemical reaction that binds it in the solid phase. In other words, preferred organic materials will do more than simply sequester hydrogen from the gas phase, but instead will irreversibly remove hydrogen from the closed system, such that it no longer exists in the device compartment. Advantageously, unlike inorganic getter materials, reaction of the organic getter with hydrogen does not produce any water byproducts that would reduce the total desiccation capabilities of the desiccant component. The organic material is preferably an unsaturated organic material, and more preferably 1,4-bis(phenylethynyl)benzene (referred to in the art as “DEB”). The hydrogenation catalyst comprises (consists essentially, or even consists of) a metal catalyst, such as palladium, platinum, rhodium, ruthenium, iridium, and/or osmium, although palladium is preferred. The metal catalyst can be supported on an inert substrate, and preferably a porous inert substrate, such as activated carbon, calcium carbonate, barium carbonate, barium sulfate, titanium silicate, alumina, and the like. In some embodiments, the hydrogenation catalyst comprises (consists essentially, or even consists of) from about 3 wt % to about 20 wt %, preferably from about 5 wt % to about 10 wt %, and more preferably about 5 wt % palladium supported on activated carbon. The weight ratio of organic material to catalyst in the getter component (inclusive of the support substrate) can range from about 50:50 to about 90:10, and is preferably about 75:25. The getter component is formed by mixing and/or milling the organic material and hydrogenation catalyst together to form particulates (e.g., particles, granules, beads, etc.), typically with an average (mean) particles size of less than about 420 microns, preferably less than about 300 microns, and more preferably less than about 150 microns. The term “particle size” is used herein to refer to the maximum surface-to-surface dimension of a particle (i.e., in the case of substantially spherical particles, the particle size would be the diameter). In some embodiments, the getter particulates can be further ground into a fine powder with an average (mean) particles size of less than about 100 microns, and preferably less than about 75 microns. Those skilled in the art will appreciate that techniques such as sieving and densifying can also be used to achieve a substantially uniform average particle size among the resulting getter particulates. In some embodiments, the getter component is a powder comprising (consisting essentially, or even consisting of) DEB-Pd on carbon (5 wt %).

The desiccant component comprises (consists essentially, or even consists of) microporous solids known as “molecular sieves,” having an average pore opening of from about 3 Å to about 10 Å. Depending upon the pore size, the desiccant will be capable of adsorbing various molecular species, and can be fine-tuned to preferentially adsorb certain species, such as water molecules, carbon dioxide, etc. In some embodiments, the molecular sieves have an average pore opening of about 3 Å. In some embodiments, a larger pore opening of about 4 Å, about 5 Å, or even about 10 Å may be desired. In some embodiments, a combination of different pore opening sizes may be used in the desiccant component to adsorb a range of liquids and gases. Preferred molecular sieves include synthetic zeolites, which can be modified through ion exchange to change the adsorption characteristics (pore size) of the microcrystalline material. Other suitable molecular sieves include natural clays, silica gels, and the like.

Suitable elastomeric matrices include elastomers such as silicone rubbers, urethane rubbers, and the like, as well as neoprene. Room temperature vulcanizable (RTV) elastomers are particularly preferred for use in the invention, such as RTV615 silicone rubber (GE) and Slygard 184 (Dow). However, heat- or UV-curable elastomers can also be used in some embodiments. Those skilled in the art will appreciate that suitable curing conditions will depend upon the chemical, physical, and mechanical tolerances of the getter component and/or desiccant component.

Additional ingredients that can optionally be included in the composite include metal organic frameworks (MOFs), carbon nano fibers, microballoons (e.g., glass microspheres), and other nanofillers. Those skilled in the art will recognize that the choice of filler will depend upon whether there is a desire for the composite to getter other selected species depending on the material chosen and/or reduce the overall density (if required). For example, microballoon can be used to lower the density of the final product should the end user have a density constraint. In some embodiments, the composite material is substantially free of any additional ingredients. For example, in some embodiments, the composite is substantially free of inorganic gas getters, such as palladium monoxide, platinum dioxide, and the like. As used herein, the term “substantially free” means that the ingredient is not intentionally added to the composite to effect the properties thereof, although incidental impurities may occur, such that the composition comprises less than about 0.5% by weight, preferably less than about 0.1%, and more preferably about 0% by weight of such an ingredient, based upon the total weight of the composite taken as 100% by weight.

The composite is formed by mixing the getter component and desiccant component with the elastomeric matrix until a substantially homogenous mixture is formed. The term “substantially homogeneous” is used herein to refer to the fact that, to the extent practicable, the components are evenly/uniformly distributed throughout the matrix such that there are consistent proportions of the components throughout any given sample of the composite mixture. Mechanical and/or centrifugal mixing techniques can be used. The materials can be mixed for a time period of from about 2 minutes to about 5 minutes for mechanical mixing, and from about 30 second to about 40 seconds for centrifugal mixing. Mixing can be carried out under ambient conditions (e.g., from about 70-80° F., and preferably about 75° F.). It will be appreciated that elastomers are typically commercially available as two-part (A part and B part) products. Accordingly, in some embodiments, the elastomeric matrix is formed by first mixing the A and B parts, prior to adding the getter and desiccant components. In some embodiments, the desiccant can be subjected to drying (e.g., via heat, vacuum, etc.) to remove any latent moisture before being added to the mixture. As noted above, the getter component can be ground into a fine powder for use in the invention. In some embodiments, the getter component is ground into a fine powder having an average (mean) particle size corresponding to the average (mean) particle size of the desiccant component to facilitate and promote uniform intermixing of the two components in the matrix.

The resulting composite mixture can then be formed into the desired shape and cured into a monolithic, self-sustaining body comprising (consisting essentially, or even consisting of) the getter and desiccant components uniformly dispersed throughout the cured elastomer matrix. The term “self-sustaining body” means that the cured composite maintains its shape without an external support structure, and is not susceptible to deformation merely due to its own internal forces. In some embodiments, the composite can be cured at about room temperature (˜25° C.) over a time period of from about 5 days to about 7 days. In some embodiments, elevated temperatures ranging from about 25° C. to about 177° C., and preferably from about 65° C. to about 170° C. can be used to reduce the cure time to less than about 24 hours, preferably less than about 4 hours, and in some cases less than about 1 hour. In some embodiments, the mixture is cured for less than about 4 hours, preferably from about 2 to about 4 hours, and more preferably about 2 hours. A post-cure can be carried out by subjecting the cured composite to additional elevated temperatures of from about 65° C. to about 170° C., for a time period of from about 10 to about 24 hours, preferably from about 15 to about 18 hours, and more preferably about 16 hours.

In some embodiments, a mold, cast, or die can be used to form the mixture into the desired size and/or shape prior to curing, using any suitable technique, such as liquid injection molding, pneumatic injection, and the like. In some embodiments, the mixture can be applied to a substrate before curing into a film. For example, the mixture can be rolled, puddled, spincoated, and/or painted into a layer on a suitable substrate, and then cured into a film of the desired thickness. The film can be removed (e.g., peeled away) from the substrate before use. Alternatively, the film can be formed directly on the intended end device as a coating and/or lining of the device compartment.

The fact that the composite can be molded into virtually any desired shape provides a significant advantage by allowing the placement of the getter and desiccant into spaces previously unattainable with conventional tube/pellet assemblies and bagged desiccants. It also eliminates the need to specifically design the device around the getter/desiccant, but instead design the getter/desiccant to fit existing voids and cavities in various devices. In addition, the overall process is simplified and costs are reduced by incorporating both functionalities into a single composite product, rather than two separate parts, as in previous methods.

In one or more embodiments, the cured composite does not need to be activated (particularly when pre-drying the desiccant) and/or does not require the presence of any other species (e.g., oxygen) to initiate scavenging of moisture and/or the target gases. Therefore, it is desirable to form and cure the composite under controlled, and preferably moisture-free conditions (e.g., in a glove box under N₂, or under other inert atmosphere conditions) to maintain the full scavenging capacity of the composite once placed in the device. In some embodiments, the composite should immediately be placed directly in the device after formation to avoid unintended exposure to moisture and/or gasses. The composite is particularly suited for use in air-filled or inert gas-filled sealed devices. In some embodiments, the composite is not suited for use in vacuum-sealed devices.

In some embodiments, the composite mixture can be stored before being cured. For example, the composite can be stored under controlled conditions that will not initiate curing of the elastomer matrix. For example, the mixture can be cooled to temperatures below about −20° C., and preferably from about −50 to about −30° C. until subjected to curing conditions (discussed above).

In one or more embodiments, the getter component of the composite will have a stoichiometric hydrogen capacity of from about 289 to about 160 cm³.atm/g, and preferably from about 241 to about 242 cm³.atm/g, at standard temperature and pressure (0° C. and 1 atm). When using a 3 Å desiccant component, the composite will have a moisture capacity of from about 0.16 to about 0.22 g of water/g of desiccant, and preferably from about 0.18 to about 0.20 g of water/g of desiccant, at standard temperature and pressure. The moisture adsorption capacity of the composite can also be reactivated, if desired, under a N₂ purge at a temperature ranging from about 65 to about 85° C., and over a time period of from about 38 to about 96 hours depending upon the size (thickness and/or surface area) of the composite.

Unlike conventional getters and desiccants, the present composite can advantageously function as a cushioning material in the device in addition to its desiccation and gas gettering capabilities. That is, the cured composite has sufficient self-supporting rigidity to form a self-sustaining body, but remains resilient and pliable, such that it is able to recoil or spring back into shape after bending, stretching, flexing, and/or compression without permanent deformation or rupture. Accordingly, the composite can be shaped to provide shock absorption between adjoining components in the device. Depending upon the configuration, this could also lessen or remove the need for separate shock absorbers in the device, further decreasing the number of separate components, and the overall cost associated with manufacturing the device.

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

Potential devices where the present composite could be useful include, without limitation, optical devices, sealed electronics, sealed shipping containers, medical devices, and the like.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods in accordance with the invention. It is to be understood, however, that these examples are provided by way of illustration and nothing therein should be taken as a limitation upon the overall scope of the invention.

### Example 1

### Combination Getter and Desiccant Composite Material

In this Example, a combination gettering and desiccant composite material was prepared. The composites were molded at a fixed volume with varying surface areas. A hydrogen getter component was prepared in-house by mixing 75 wt % of 1,4-bis(phenylethynyl)benzene (crystalline solid; Kemex Laboratories, Painesville, Ohio) with 25 wt % of a supported palladium catalyst (5% palladium on activated carbon; Strem Chemicals, Inc., Newburyport, Mass.) in a ball mill, followed by sieving, and densifying/pressing (if necessary). The palladium-catalyzed DEB getter was ground into a fine powder for use in the composite. To prepare the composite composition, a 3 Å zeolitic molecular sieve desiccant (synthetic potassium-form alumino silicate; W.R. Grace & Co., Columbia, Md.) was first dried under nitrogen purge for 48 hours at 428° F., and then immediately weighed into batches in a glovebox. Next, the A and B parts of an RTV silicone rubber (RTV615; GE Silicones) were premixed before being used in the composite. The dried desiccant powder and palladium-catalyzed DEB getter were then mixed into the silicone rubber in a 2.5 oz Semco cartridge using a Thinky Planetary Centrifugal mixer (model ARE-250) at 1900 rpm for 0.5 minutes. The components were mixed at a weight ratio of 50:45:5 silicone:desiccant:getter until a substantially homogeneous mixture was formed, with the desiccant and getter evenly distributed throughout the silicone matrix.

The mixture was then degassed under vacuum and injected into the molds. Each sample was molded in triplicate. All molding was done within a dry nitrogen glovebox kept at less than a −40° C. frost point, followed by curing for 2 hours at 170° F., and then 16 hours post-cure at 170° F. Different-shaped molds were used to create composites having various surface areas at the same total volume of the composite material. The surface area to volume ratios produced were 20.0, 24.0, 31.4, and 41.3. After post-cure, the cured composites were removed from the mold and deburred.

### Example 2

### Hydrogen Gas Gettering and Moisture Adsorption

The ability of the composites formed in Example 1 to remove hydrogen gas and adsorb moisture were tested.

### 1. Moisture Adsorption

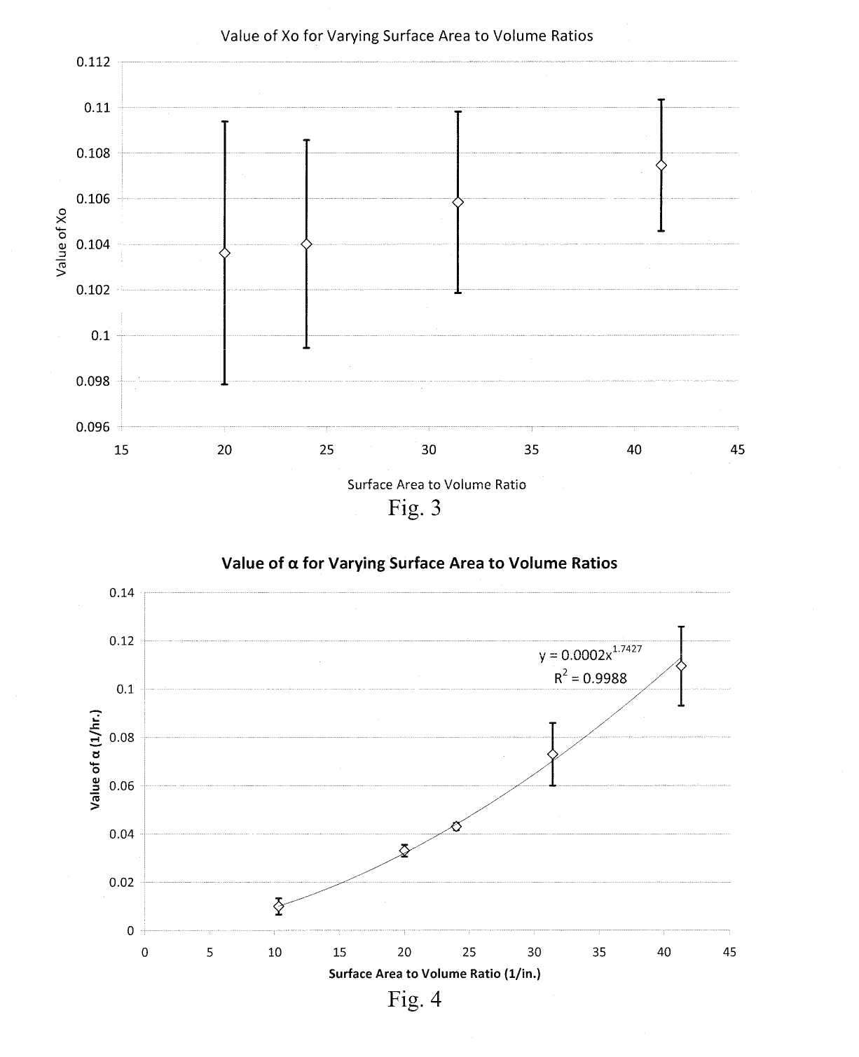

To test the moisture adsorption of the composites, the samples were initially weighed in under inert conditions and then removed from the glovebox and immediately placed in a humidity chamber kept at 98% relative humidity. The samples were then weighed periodically until their weights stabilized. The moisture uptake data was analyzed using Excel and MATLAB using a Gauss-Newton nonlinear method to tit the data to the following equation: w(t)=−xₒc^{-αt}+xₒ+xᵢ, where xᵢ is the initial weight, xₒ is the total amount of weight change at time t=∞, and α is the rate at which the weight is changing (1/hr). The results are shown in FIGS. 2-4.

All of the samples adsorbed, on average, 10.52% by weight of water. Importantly, these values were not statistically different among the different surface areas tested. The ability of the individual gettering and desiccant components was not hindered by their inclusion in an elastomeric matrix, or their combination into a single composite article.

Note that instead of a 3 Å molecular sieve, those with larger pore openings of 4 Å, 5 Å, or even 10 Å could be used to capture a different range of gas species.

### 2. Hydrogen Gettering

To test the hydrogen gettering capabilities of the composites and determine if the addition of desiccant to the composite has a detrimental effect on the hydrogen reaction, samples were prepared according to Example 1, keeping the DEB percentage constant but varying the amount of desiccant. Sample #1 contained 60 wt % silicone matrix, 35 wt % 3 Å molecular sieve desiccant, and 5 wt % prepared DEB getter powder. Sample #2 contained 50 wt % silicone matrix, 45 wt % 3 Å molecular sieve desiccant, and 5% prepared DEB getter powder. The pressure gages were calibrated. Next, a 5 to 10 gram portion of each sample was placed in a Parr bomb calorimeter, which was then evacuated to less than 1 torr and backfilled with helium gas.

The evacuation and backfill was repeated two more times. The test vessel valve was then closed. The hydrogen ballast was then filled to approximately 750 Torr of hydrogen gas, and the valve to the ballast was closed. The test vessel and all lines to the ballast were closed once more to 0.05 torr or less. Finally, the vacuum valve was closed as the ballast gas was expanded into the test vessel. The pressure was then recorded as the hydrogen was scavenged by the getter in the composite samples.

To analyze the data, the ideal gas laws were used to determine the hydrogen capacity of each sample as a percent of the Theoretical percentage by the following formula:

HC=(PV/RT)(100)/(% organic)(4)(SW)(0.00360),

where:

HC=Hydrogen capacity (%)

P=the change in hydrogen gas pressure (initial−final) in kilopascals (kPa)

V=volume of the test system (ballast+vessel and all lines) in cubic meters (m³)

T=Temperature in degrees Kelvin (K)

R=universal gas constant 8.314×10⁻³ (kPa)(m³)/(° K) (g-moles)

% organic=the average decimal weight percent of organic material

4=number of moles of hydrogen reacted per mole of organic material

SW=sample weight in grams (g)

0.00360=(g-moles organic/g organic)

100=conversion factor for decimal to percent

The results were as follows:

### Sample 1

### Tester Unit #1

SW=5.660 g, P=2.113 kPa, V=0.002587 m³, T=298.15° K, % Organic=0.0375

HC=72.41%

### Sample 2

### Tester Unit #3

SW=5.259 g, P=1.685 kPa, V=0.002606 m³, T=298.15° K, % Organic=0.0375

HC=62.66%

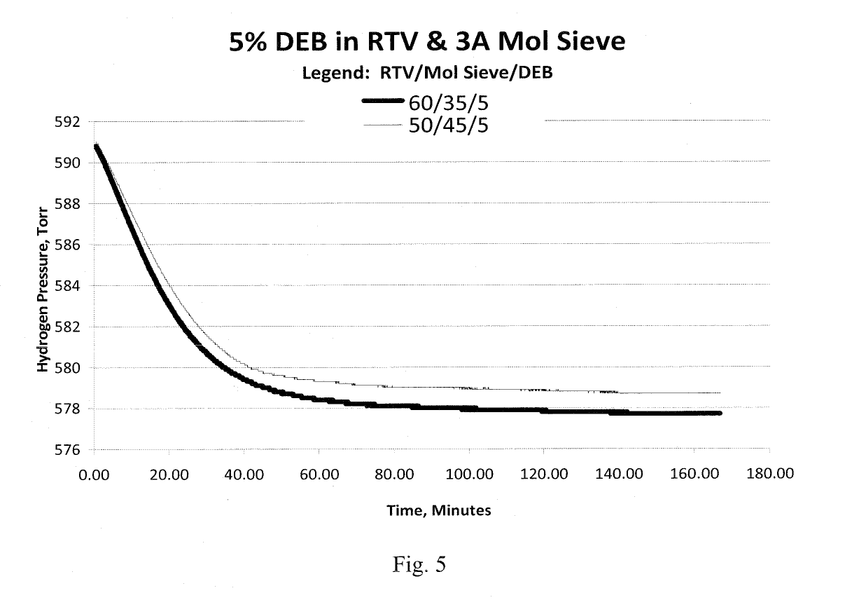

The graph in FIG. 5 illustrates the results, which demonstrate the ability of the composite samples to getter the hydrogen gas.

What is claimed:

1. A composite useful for both gas gettering and moisture adsorption comprising an organic getter component and a desiccant component homogeneously dispersed in an elastomeric matrix.

2. The composite of claim 1, wherein said getter component comprises an organic material capable of reacting with hydrogen and a hydrogenation catalyst.

3. The composite of claim 2, wherein said organic material is 1,4-bis(phenylethynyl)benzene.

4. The composite of claim 2, wherein said hydrogenation catalyst comprises a metal selected from the group consisting of palladium, platinum, rhodium, ruthenium, iridium, osmium, and combinations thereof.

5. The composite of claim 4, wherein said metal is supported on an inert substrate.

6. The composite of claim 5, wherein said hydrogenation catalyst comprises from about 3 wt % to about 20 wt % palladium supported on activated carbon.

7. The composite of claim 2, wherein the weight ratio of organic material to catalyst in the getter component is from about 50:50 to about 90:10.

8. The composite of claim 1, wherein said desiccant component comprises a molecular sieve having an average pore opening of from about 3 Å to about 10 Å.

9. The composite of claim 8, wherein said molecular sieve is zeolite.

10. The composite of claim 1, wherein said elastomeric matrix is selected from the group consisting of silicone rubber, urethane rubber, neoprene, and combinations thereof.

11. The composite of claim 1, wherein said elastomeric matrix is a room temperature vulcanizable elastomer.

12. The composite of claim 1, wherein said composite comprises from about 3 to about 25% by weight of the getter component, based upon the total weight of the composite material taken as 100% by weight.

13. The composite of claim 1, wherein said desiccant component is present in the composite at a level of from about 25 to about 47% by weight, based upon the total weight of the composite taken as 100% by weight.

14. The composite of claim 1, wherein said elastomeric matrix is present in the composite at a level of at least about 50% by weight, based upon the total weight of the composite taken as 100% by weight.

15. The composite of claim 1, wherein said composite consists essentially of said organic getter component and desiccant component homogeneously dispersed in said elastomeric matrix.

16. The composite of claim 1, wherein said composite is substantially free of inorganic gas getters.

17. The composite of claim 1, wherein said composite is in the form of a resilient, self-sustaining body.

18. The composite of claim 1, further comprising an additional ingredient selected from the group consisting of metal organic frameworks, carbon nanofibers, microballoons, nanofillers, and combinations thereof.

19. A method of forming a composite useful for both gas gettering and moisture adsorption, said method comprising:
(a) providing an organic getter component comprising an organic material capable of reacting with hydrogen and a hydrogenation catalyst;
(b) providing a desiccant component;
(c) mixing said getter component and said desiccant component with an elastomeric matrix to form a composite mixture; and
(d) curing said composite mixture to form a cured composite.

20. The method of claim 19, wherein said elastomeric matrix comprises A part and B part, further comprising combining said A part and B part to form said elastomeric matrix before mixing said getter component and said desiccant component with said elastomeric matrix.

21. The method of claim 19, wherein said providing a desiccant component (b) comprising drying said desiccant component prior to said mixing.

22. The method of claim 19, wherein said providing an organic getter component (a) comprises milling said organic material and said hydrogenation catalyst together to form particulates of said organic getter component.

23. The method of claim 22, wherein said particulates are ground into a fine powder before mixing with said desiccant component.

24. The method of claim 19, further comprising injecting said composite mixture into a mold prior to said curing (d).

25. The method of claim 19, further comprising forming a layer of said composite mixture on a substrate prior to said curing (d).

26. The method of claim 19, wherein said curing comprises heating said composite mixture to a temperature of from about 25° C. to about 177° C., for a time period of less than about 24 hours.

27. The method of claim 19, further comprising the step of post-curing said cured composite at a temperature of from about 65° C. to about 170° C., for a time period of from about 10 to about 24 hours.

28. The method of claim 19, wherein said cured composite is a resilient, self-sustaining body comprising said organic getter component and desiccant component uniformly dispersed through the cured elastomeric matrix.

29. The method of claim 19, further comprising placing said cured composite in the compartment of a device, filling said compartment with air or inert gas, and sealing said device.

30. The method of claim 29, wherein said device is selected from the group consisting of optical devices, sealed electronics, sealed shipping containers, medical devices, and combinations thereof.

31. A kit for forming a composite useful for both gas gettering and moisture adsorption, said kit comprising:
an organic getter component comprising an organic material capable of reacting with hydrogen and a hydrogenation catalyst;
a desiccant component;
an elastomeric matrix component comprising separate A and B parts; and
instructions for: combining part A and part B for forming said elastomeric matrix, mixing said organic getter component and said desiccant component in said elastomeric matrix to form a composite mixture, and curing said composite mixture to form said composite.
